(19) United States
(12) Patent Application Publication
(10) Pub. No.: US 2025/0102406 A1
(43) Pub. Date: Mar. 27, 2025

(54) SYSTEM FOR DETERMINING THE PROPORTION OF AT LEAST ONE IMPURITY IN A CRYOGENIC LIQUID

(71) Applicant: L'Air Liquide, Societe Anonyme pour l'Etude et l’Exploitation des Procedes Georges Claude, Paris (FR)

(72) Inventors: Frederic CRAYSSAC, Paris (FR); Patrick LE BOT, Paris (FR); Daniel MACHON, Paris (FR)

(21) Appl. No.: 18/890,893

(22) Filed: Sep. 20, 2024

(30) Foreign Application Priority Data
Sep. 21, 2023 (FR) FR 2309982

(51) Int. Cl. G01N 1/40; F25J 3/04

(52) U.S. Cl. CPC G01N 1/4022; F25J 3/04769; G01N 2001/4027

(57) ABSTRACT

The present invention relates to a determination system for determining the content of at least one impurity in a cryogenic liquid, comprising:
a vessel capable of receiving an initial volume of the cryogenic liquid,
vaporization means for vaporizing the initial volume of cryogenic liquid until a volume of residual cryogenic liquid is obtained in which the impurity is concentrated, the vaporization means being disposed in the lower part of the vessel and
means for determining the proportion of the impurity in the residual cryogenic liquid,
wherein that the vaporization means comprise a heating surface capable of vaporizing the cryogenic liquid, the vaporization means being configured to keep said heating surface wet using the volume of residual cryogenic liquid.

### CROSS REFERENCE TO RELATED APPLICATIONS

This application claims the benefit of priority under 35 U.S.C. § 119 (a) and (b) to French patent application No. FR2309982, filed Sep. 21, 2023, which is herein incorporated by reference in its entirety.

### FIELD OF THE INVENTION

The present invention concerns the chemical industry and relates to a system for determining the proportion of at least one impurity dissolved in a cryogenic liquid, for example sampled from a system for separating gases from air, and to a corresponding determination method.

### BACKGROUND OF THE INVENTION

A system for separating gases from air comprises low- and medium-pressure distillation columns for separating the various constituents from air. Although the air is purified before it enters the columns, impurities remain in the feed air of the columns and are concentrated in particular in an oxygen vaporizer in one of the columns. To be specific, most of these impurities have a liquid/vapour equilibrium coefficient such that almost all of these impurities stay in the liquid phase of the vaporizer, with vanishingly few of the impurities leaving the vaporizer again in the gas phase. The proportion of impurities in the liquid phase therefore increases with successive vaporization cycles and ultimately builds up in the form of a liquid or solid deposit in the aluminium matrix of the vaporizer.

Adsorption processes, implemented before the distillation, make it possible to eliminate heavy hydrocarbons, in other words those having more than four carbon atoms, and hydrocarbons having unsaturated bonds from the feed air of the columns. The impurities, which are barely or not at all caught by these adsorption processes, are in particular light hydrocarbons and propane. Light hydrocarbons having one or two carbon atoms are highly soluble in oxygen, and therefore do not give rise to a pure phase which can react with the oxygen in the vaporizer. However, propane is relatively insoluble in oxygen and can thus give rise to a pure phase which, when it comes into contact with the liquid oxygen in the vaporizer, can generate an explosive situation, in particular when the energy released by this impurity is enough to trigger the combustion of the aluminium matrix of the vaporizer.

Moreover, even when the impurity present in the vaporizer is not reactive with oxygen, it accelerates the build-up of all the other impurities, and therefore also of impurities which are reactive with oxygen. This is in particular the case with carbon dioxide and nitrous oxide, which have a solidification temperature that is above the operating temperature of liquid oxygen. It is possible that these impurities are not caught by the adsorption processes and give rise to a solid phase in the liquid oxygen of the vaporizer, and this can block the vaporization ducts of the vaporizer. This mechanism, referred to as “dead end boiling”, accelerates the concentration of all the impurities contained in the liquid being vaporized, in particular hydrocarbons, and therefore increases the risk of combustion of the vaporization matrix.

It is therefore necessary to monitor the proportion of impurities entering the distillation columns and/or the oxygen bath of the vaporizer in order to maintain acceptable maximum amounts of impurities there and to ensure the operating safety of the system for separating gases from air.

One difficulty to be overcome is that the levels of impurities to be measured are extremely low, given the very low solubilities and liquid/vapour equilibrium coefficients of these impurities, especially for carbon dioxide and nitrous oxide. In order to be able to control acceptable maximum amounts of impurities, it is necessary to measure proportions of less than 100 ppb (parts per billion), and preferably between 10 and 50 ppb. These measurements may be continuous or be carried out at a frequency allowing action to be taken well before a critical proportion of impurities is reached.

Currently, techniques for determining the content of impurities in the air to be distilled or in the oxygen of the vaporizer use complex equipment and require considerable operational skill. These techniques only use gas analysers, which require that the cryogenic liquid entering the distillation columns or the vaporizer be sampled and vaporized in a special apparatus so that it can then be analysed. With preference, the sample is taken at the inlet of the vaporizer, or at the outlet of the vaporizer, or between various vaporization stages as appropriate, given that the vaporizer is a critical point of the system for separating gases from air.

These prior art techniques involve complete vaporization of the sample along with its impurities so as to obtain a gas to be analysed, in which the proportion of impurities is identical to the proportion of impurities in the sample of cryogenic liquid, the vaporization being carried out under conditions which prevent a build-up of impurities in the device for sampling or vaporizing the sample, so as to not distort the measurements taken by the gas analyser.

In order to make it easier to measure the proportion of impurities in the cryogenic liquid, the inventors have developed an apparatus and a method for analysing this proportion, which are described in documents FR3066596 and FR3066597. The apparatus allows vaporization of a large amount of a sample of cryogenic liquid to be analysed in a vessel, the gas thus vaporized being discharged in an open circuit, a residual amount of cryogenic liquid in which the impurities of the sample are concentrated being retained at the end of this vaporization. The vessel is then kept closed and the residual amount of cryogenic liquid is completely vaporized in the vessel, so as to obtain a gas that has a proportion of impurities much higher than that of the initial sample, and hence is much easier for a gas analyser to measure.

This innovative approach requires that the impurities of which the concentration is to be measured are less volatile than the cryogenic liquid in which they are present, but also that the amount of impurities that evaporate during the vaporization in an open circuit is negligible compared to the amount of impurities remaining in the residual cryogenic liquid. These conditions depend on values of thermodynamic equilibrium between the impurities and their solvent, which themselves depend on the vaporization pressure and temperature. The lower the vaporization pressure, the more the vaporization is conducive to the concentration of impurities in the residual cryogenic liquid.

On the basis of these values of thermodynamic equilibrium, the concentration of impurities in the residual cryogenic liquid should not present a problem. To be specific, depending on these values, when the residual cryogenic liquid is oxygen which is maintained at 15 bar, the amount of nitrous oxide, or of carbon dioxide, or of propane, escaping as vapour during the vaporization in an open circuit remains less than 2% of the amount of impurities remaining in the cryogenic liquid.

However, the inventors have noted that the amount of impurities escaping in the gas phase during the vaporization in an open circuit can actually be much higher when the vaporized cryogenic liquid has areas over-concentrated with impurities, or when vaporization of the cryogenic liquid to dryness takes place on the wall of the apparatus that transmits the heat of vaporization. In particular, if this wall is overheated, the thermodynamic equilibrium is skewed and the amount of impurities escaping in the gas phase is greater. To avoid such overheating, the concentration of impurities can be carried out at a pressure higher than atmospheric pressure, but this does not prevent the formation of areas over-concentrated with impurities in the liquid.

It should be noted that the prior art techniques proposing total vaporization of a sample of cryogenic liquid do not make it possible to vaporize the cryogenic liquid at the bubble temperature without it vaporizing locally to dryness on part of the heating wall of the vaporization device, and causing a deposition of impurities on this heating wall, which loads the gas formed by vaporization with impurities.

Lastly, another difficulty with the approach proposed by the inventors is that, to significantly concentrate the impurities in the residual cryogenic liquid, with a concentration factor greater than or equal to 100, it is necessary to vaporize 99% of the sample of cryogenic liquid in an open circuit, and this makes it difficult to not have a heating wall that vaporizes the cryogenic liquid to dryness during this vaporization step in an open circuit. This is all the more difficult if, to ensure the safety of the system for separating gases from air, the duration of an analysis cycle is limited to less than one hour. To be specific, the analysis apparatus proposed by the inventors operates in cycles, during which the vessel in which the sample is to be vaporized must be cooled after all the residual cryogenic liquid has been vaporized and delivered to a gas analyser, in order to receive another sample.

### SUMMARY OF THE INVENTION

The present invention aims to overcome at least some of the aforementioned drawbacks by providing a system and a method for determining the proportion of at least one impurity in a cryogenic liquid, and a system for separating gases from air, which make it possible to concentrate the impurity in a portion of the liquid before vaporization of this portion of liquid and delivery of the vapour thus produced to a gas analyser, with a concentration factor which is not distorted by excessive vaporization of the impurities while the impurity is being concentrated in the portion of cryogenic liquid.

To this end, the invention proposes a system for determining the proportion of at least one impurity dissolved in a cryogenic liquid, the at least one impurity being less volatile than the cryogenic liquid, comprising:
a vessel capable of receiving an initial volume of the cryogenic liquid,
vaporization means for vaporizing the initial volume of cryogenic liquid until a volume of residual cryogenic liquid is obtained in which the impurity is concentrated, the vaporization means being disposed in the lower part of the vessel and comprising a heating surface capable of vaporizing the cryogenic liquid, and
means for determining the proportion of the impurity in the residual cryogenic liquid,
the determination system being characterized in that the vaporization means comprise at least one cryogenic liquid intake duct and a plurality of cryogenic liquid discharge ducts, the vaporization means being capable of producing a thermosiphon effect between the intake duct and the plurality of discharge ducts, the heating surface comprising the internal surfaces of the discharge ducts.

In other words, the vaporization means are configured to keep said heating surface wet using the volume of residual cryogenic liquid.

By virtue of the invention, the vaporization of the initial volume of cryogenic liquid making it possible to concentrate the impurity in the volume of residual cryogenic liquid is done without a non-negligible amount of the impurity escaping into the gas phase during this vaporization. To be specific, the heating surface of the vaporization means which allows this vaporization is entirely submerged or entirely wetted by the volume of residual cryogenic liquid. There is thus no vaporization of the cryogenic liquid to dryness that may create deposits on this heating surface. It is defined as allowing the vaporization of the cryogenic liquid, and therefore releasing a heat which allows this vaporization. Other surfaces of the vaporization means can be relatively hot compared to the cryogenic liquid without allowing the latter to vaporize. The heating surface is for example formed in the lower part of the vessel.

The thermosiphon effect, produced by the vaporization means, makes it possible to agitate the cryogenic liquid and hence to avoid the formation of areas over-concentrated with impurities in the cryogenic liquid, and this also avoids excessive vaporization of these impurities.

In the invention, the discharge ducts are those that allow the vaporization of the cryogenic liquid, since their internal surface heats the cryogenic liquid to a temperature allowing this vaporization. The vaporization means are for example arranged in a lower part of the vessel so as to at least partially submerge the discharge ducts in the volume of residual cryogenic liquid under the effect of gravity, the very internal surface of the discharge ducts that is not submerged by the residual cryogenic liquid staying wet by virtue of the circulation of residual cryogenic liquid in the discharge ducts owing to the thermosiphon effect.

In one embodiment, the discharge ducts surround for example the intake duct. In addition, the discharge ducts have a smaller diameter than the intake duct does. Distributing the cryogenic liquid in the discharge ducts of small diameter in this way makes it easier for the cryogenic liquid to evaporate and for the heating surface of these ducts to be kept wet. The intake and discharge ducts preferably have a circular cross section and the intake ducts are preferably angularly evenly distributed around the intake duct.

The vaporization means comprise, for example, a thermally conductive body of cylindrical overall shape, through the height of which are made the intake and discharge ducts, which emerge on a face of the body that delimits a bottom part of the vessel.

The bottom part of the vessel forms for example a part of the lower part of the vessel, with the same surface area as the face of the body, corresponding to a base of its cylindrical shape. This face is thus flat if the orifices of the ducts emerging on this face are disregarded. It is flush for example with the lower part of the vessel, in order to allow the evaporation means to accommodate by gravity all the volume of residual cryogenic liquid, forming for example one percent or at least one percent of the initial volume of cryogenic liquid. The ducts are thus disposed vertically with respect to the ground, the face delimiting the bottom part of the vessel being disposed horizontally.

The thermally conductive body is a good thermal conductor, for example made of copper or aluminium and preferably forming a one-piece component. The surface of this body is for example smooth or textured, in particular the internal surfaces of the discharge ducts have for example a surface which improves the vaporization heat exchange coefficient and/or the wetting of the wall owing to its roughness, its texturing geometry, the presence of micro-fins or other means.

The body preferably comprises a thermally insulating lining disposed between the intake duct and the discharge ducts. As a result, the cryogenic liquid in the intake duct remains quite cold so as to not vaporize there and form deposits on the internal surface of the intake duct. This insulating lining is for example made of polytetrafluoroethylene (also referred to as “Teflon®”).

The vaporization means in particular comprise at least one electric heater disposed in a recess of the body proximal to the discharge ducts. This heater is for example a heating resistor or a heating cartridge, disposed between the intake duct and the discharge ducts, or around the discharge ducts.

With preference, the vaporization means comprise multiple electric heaters in the form of heating cartridges, the body having spaces which are disposed around the discharge ducts and accommodate the heating cartridges, the spaces not emerging on the face of the body that delimits the bottom part of the vessel. These spaces extend parallel to and at a distance from the discharge ducts in the thermally conductive body, but quite close to one another to keep the internal surfaces of the discharge ducts at a temperature that allows the vaporization of the cryogenic liquid. They are preferably angularly evenly disposed around the discharge ducts.

The spaces are for example separated by recesses around the circumference of the body, over at least part of the height of the body. These recesses limit the mass of the body to be heated by the heating cartridges during the vaporization of the cryogenic liquid, but also the mass of the body to be cooled during a subsequent step for bringing the walls of the vessel to a filling temperature. This subsequent step is necessary to carry out a new determination of the impurity proportion in a new initial volume of cryogenic liquid, which must be able to be assessed precisely when it fills the vessel.

The recesses between the spaces accommodating the heating cartridges give the cylindrical overall body for example the form of a barrel, by opening out onto the external cylindrical wall of the body. They make it possible to reduce the cost of the determination system according to the invention.

The body has an opposite face to the face delimiting the bottom part of the vessel and the vaporization means comprise in particular a manifold disposed on the opposite face, the manifold fluidically connecting the intake duct to the discharge ducts. This manifold is for example a copper component fitted to the opposite face of the body, comprising a fluid circulation chamber. Since the manifold is disposed vertically underneath the body, it is always filled with residual cryogenic liquid and therefore does not permit the formation of impurity deposits.

In order to cool the vessel between two vaporization steps for two separate determinations according to the invention, a jacket surrounds the vaporization means, the jacket being configured to contain a cooling liquid that comes into contact with the vaporization means. Of course, other cooling means are conceivable.

The jacket is for example an annular jacket surrounding at least the lower part of the vessel, which is for example a cylindrical tank.

With preference, the opposite face emerges out of the jacket, the intake and discharge ducts extending through the jacket from the face delimiting the bottom part of the vessel. This makes it easier to supply power to the one or more heaters. The opposite face has for example orifices for insertion of heating cartridges into the spaces. This also makes it easier to install and replace these cartridges.

Another subject of the invention is a system for separating gases from air by cryogenic distillation, comprising a system for determining the proportion of at least one impurity dissolved in a cryogenic liquid according to the invention, means for taking a sample of fluid circulating in the separation system, means for liquefaction of the fluid sampled, if it is gaseous, and means for delivering the fluid sampled, and possibly liquefied, to the vessel so as to determine its impurity proportion.

Of course, the system and the method for determining the content of at least one impurity dissolved in a cryogenic liquid of the invention are applicable to other systems, for example to a system for separating another type of gas, from which carbon dioxide is to be separated, for example.

The invention also relates to a method for determining the proportion of at least one impurity dissolved in a cryogenic liquid, the at least one impurity being less volatile than the cryogenic liquid, using the system for determining the proportion of at least one impurity according to the invention and comprising the following steps:
filling the vessel with the initial volume of cryogenic liquid, kept at a filling temperature and pressure that prevent the cryogenic liquid from vaporizing during this filling step,
vaporizing the cryogenic liquid until the volume of residual cryogenic liquid is obtained by the vaporization means, bringing the cryogenic liquid to its vaporization temperature at the pressure of the cryogenic liquid during this vaporization step, this pressure being less than or equal to the filling pressure, the gas produced by the vaporization being discharged from the vessel, and
determining the proportion of the impurity in the residual cryogenic liquid.

The filling temperature and the filling pressure fall within respective temperature and pressure ranges that correspond to a liquid state of the element or compound forming the cryogenic liquid. The cryogenic liquid is air in the liquid state or oxygen in the liquid state, downstream of the location where the cryogenic liquid was sampled in the system for separating gases from air according to the invention. This sample is specifically for example taken at the inlet of the distillation columns of the system for separating gases from air, or else at the inlet of an oxygen vaporizer in one of these columns, or at the outlet of the oxygen vaporizer, or else between different vaporization stages, where appropriate.

The vaporization step is performed at atmospheric pressure or under vacuum controlled by way of a vacuum-generating system such as a vacuum pump or an ejector. For example, the pressure within the vessel during the vaporization step is brought to a value ranging between 0.2 bar and 0.3 bar and preferably equal to 0.2 bar. This makes it possible to lower the vaporization temperature and consequently to even further reduce the liquid/vapour equilibrium coefficients. Moreover, this increases the difference in temperature between the heating surface and the cryogenic liquid, this making it possible to reduce the duration of the vaporization step.

The amount of cryogenic liquid vaporized during the vaporization step is controlled so as to have precise knowledge of the concentration factor corresponding to the ratio between the initial volume of cryogenic liquid and the volume of residual cryogenic liquid. This can be done by monitoring the duration of the vaporization step and the temperature and pressure parameters during this vaporization step.

Then, the determination step comprises taking a sample of the residual cryogenic liquid and then vaporizing the sampled liquid to afford a gas, or else vaporizing all the residual cryogenic liquid to afford a gas and then delivering the gas obtained by vaporization of the sampled liquid or all the residual cryogenic liquid to a gas analyser. As a result, the gas analyser must detect a concentrated impurity proportion and thus does not need to be very precise or very expensive.

In order to tightly control the impurity proportion in the cryogenic liquid in the gas separation system according to the invention, the determination method according to the invention comprises a step of emptying the vessel, followed by a step of cooling the vessel by introducing a liquid at a temperature less than or equal to the filling temperature of the cryogenic liquid into the jacket of the determination system. The emptying step follows the sampling of the residual cryogenic liquid, or the delivery of the gas obtained by vaporization of all the residual cryogenic liquid, so as to not disrupt the determination of the impurity proportion carried out by the gas analyser. Once it has cooled, the vessel can receive a new initial volume of cryogenic liquid sampled from the system for separating gases from air, to carry out a new determination of its impurity proportion.

### BRIEF DESCRIPTION OF THE DRAWINGS

The invention will be understood better from reading the following description and from studying the accompanying figures. These figures are given only by way of illustration and do not in any way limit the invention.

FIG. 1 shows steps of a method for determining the proportion of at least one impurity dissolved in a cryogenic liquid according to the invention, in one embodiment of the invention,

FIG. 2 shows a system for determining the proportion of at least one impurity dissolved in a cryogenic liquid according to the invention, in one embodiment of the invention, the system comprising in particular a vessel and vaporization means which are shown in section in the bottom part of the vessel,

FIG. 3 shows a perspective view of an element of the vaporization means shown in FIG. 2,

FIG. 4 is a perspective view of a section through the element in FIG. 3, and

FIG. 5 shows steps of a method for determining the proportion of at least one impurity dissolved in a cryogenic liquid according to the invention, in a variant of the embodiment of the invention shown in FIG. 1.

### DETAILED DESCRIPTION OF THE INVENTION

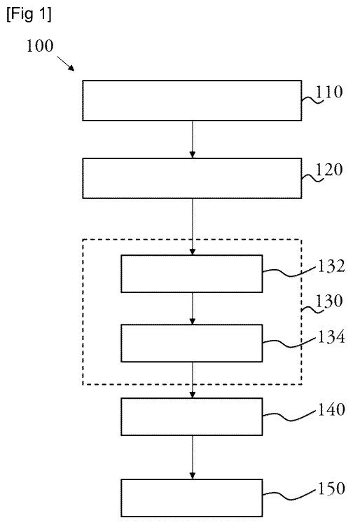

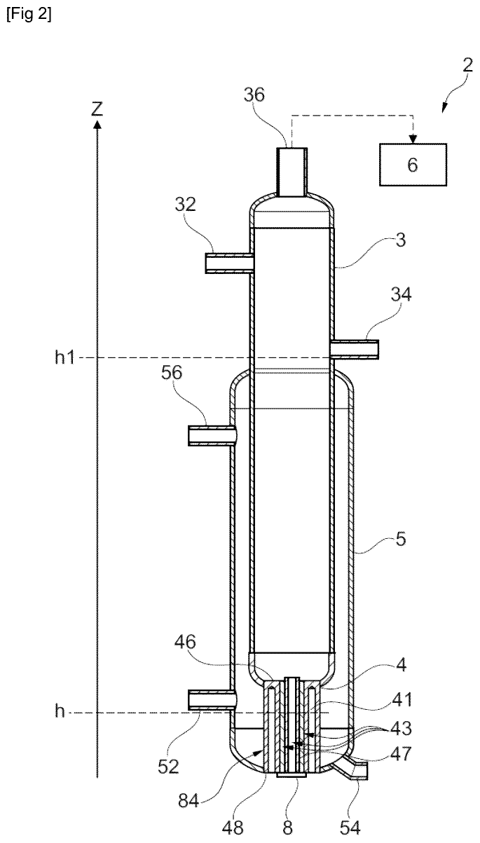

According to an embodiment of the invention shown in FIG. 1, a determination method 100 according to the invention for determining the proportion of at least one impurity dissolved in a cryogenic liquid is implemented by a determination system 2 according to the invention for determining the proportion of at least one impurity dissolved in a cryogenic liquid, shown in FIG. 2, this determination system 2 forming part of a system for separating gases from air by cryogenic distillation according to the invention.

The at least one impurity for which the proportion is determined is for example propane. The proportions of impurities other than propane in the cryogenic liquid are of course also preferably determined by the determination method 100, the determination system 2 allowing such multiple determinations. The impurities determined in this embodiment of the invention are less volatile than the cryogenic liquid.

This system for separating gases from air comprises means for taking a sample of fluid circulating in the separation system. In this embodiment of the invention, it is assumed that these sampling means take a sample of liquid oxygen at the inlet of an oxygen vaporizer of the gas separation system, this oxygen vaporizer being disposed in a distillation column of the gas separation system. The liquid oxygen thus sampled is delivered to the determination system 2.

This system comprises a vessel 3 in the form of a cylindrical tank, which is capable of containing liquid oxygen and disposed vertically on legs, which are not shown. The vessel 3 has a liquid inlet 32, a liquid outlet 34 and a gas outlet 36.

The liquid oxygen sampled from the separation system is delivered to the vessel 3, through the liquid inlet 32 on the vessel 3, during a first step 110 of the determination method 100, which is a step of filling the vessel 3 with an initial volume of cryogenic liquid, which is to say in this case liquid oxygen.

This initial volume of cryogenic liquid is predetermined. In order to obtain it precisely, the vessel 3 is filled until the cryogenic liquid overflows from the vessel 3 through the liquid outlet 34, the position of which on the vessel 3 is determined such that the vessel 3 is filled with the predetermined initial volume of cryogenic liquid when this liquid reaches the liquid outlet 34.

The height of the cryogenic liquid in the vessel 3 is then h1. This height is measured vertically with respect to the ground along a vertical axis Z.

During the filling step 110, the pressure and the temperature of the cryogenic liquid prevent it from vaporizing. The temperature of the cryogenic liquid is in particular lower than its vaporization temperature at the pressure to which it is subjected during this step.

The subsequent step of the determination method 100 is a step of vaporizing 120 the cryogenic liquid until a volume of residual cryogenic liquid is obtained. In this step, the liquid inlet 32 and outlet 34 on the vessel 3 are closed, while the gas outlet 36, disposed at the top of the vessel 3, is open. To be specific, the cryogenic liquid converted into vapour is discharged during this vaporization step 120 via the gas outlet 36.

This vaporization is carried out by vaporization means 84 disposed in the lower part of the vessel 3, which bring the cryogenic liquid to its vaporization temperature, a vacuum being applied to obtain the vaporization pressure in the vessel 3 until a pressure of around 0.2 bar absolute is reached. By virtue of this low pressure, the vaporization temperature (or bubble temperature) is lower than at atmospheric pressure, and this reduces the duration of the vaporization step 120. Moreover, this low pressure lowers the liquid/vapour equilibrium coefficients, preventing a large quantity of impurities from being allowed to escape into the gas phase.

The vaporization step 120 makes it possible to concentrate the impurities present in the initial volume of cryogenic liquid, in a volume of residual cryogenic liquid preserved at the end of the vaporization step 120. This volume of residual cryogenic liquid is predetermined by controlling the amount of gas vaporized during this vaporization step 120, or by controlling the duration of this step and the temperature and pressure parameters in the vessel 3 during this vaporization step 120, or by measuring a variation in the level of liquid and/or mass in the vessel 3. In this way, the concentration factor of the impurities in the volume of residual cryogenic liquid is precisely determined as the ratio between the initial volume of cryogenic liquid and the volume of residual cryogenic liquid. By way of indication, in this embodiment of the invention, the vessel 3 has a capacity of 1.3 litres and the initial volume of cryogenic liquid is 0.8 litres.

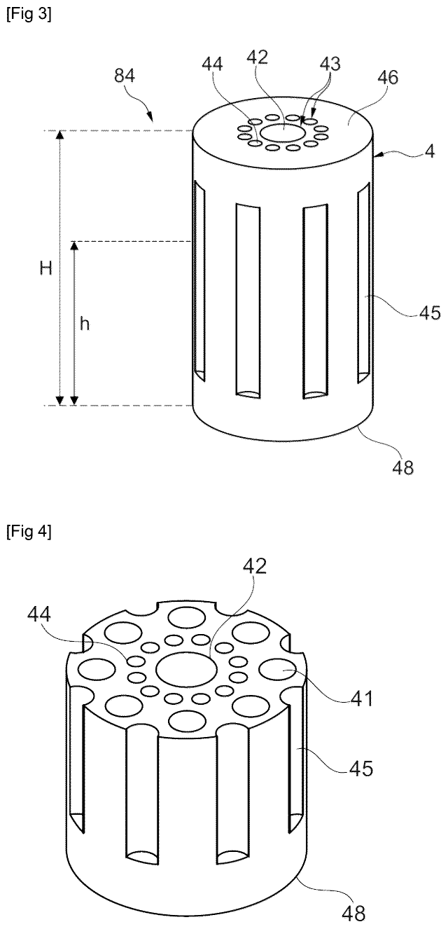

The vaporization means 84 can be seen more particularly in FIG. 3. They comprise a copper body 4 with the overall shape of a cylinder of height H. The body 4 is disposed along this height H vertically in the lower part of the vessel 3, such that a face 46 of the body that corresponds to a base of the cylinder is disposed horizontally and forms a bottom part of the vessel 3. In other words, the base of the cylindrical tank that forms the vessel 3 is partially formed by the face 46 of the body 4, which is flush with the aluminium walls of the cylindrical tank.

An opposite face 48 of the body 4 that corresponds to the other base of the cylinder is therefore disposed horizontally proximal to the ground in relation to the face 46 forming the bottom part of the vessel 3.

The body 4 has, over its height, vertically disposed ducts 43 passing through it, namely an intake duct 42, in the centre of the body 4, and discharge ducts 44 surrounding the intake duct 42. The discharge ducts 44 have a smaller diameter than the intake duct 42 does. A copper manifold 8 is fitted to the opposite face 48 so as to establish fluidic communication between the intake duct 42 and the discharge ducts 44. The manifold 8 forms part of the vaporization means 84.

Naturally, the lower part of the vessel 3 and the vaporization means 84 form leaktight means for containing the cryogenic liquid.

The vaporization means 84 also comprise heating cartridges accommodated in spaces 41 (visible in FIG. 4) disposed in the body 4 around the discharge ducts 44. These spaces 41 extend parallel to the discharge ducts 44 in the body 4, without emerging on the face 46 forming the bottom part of the vessel 3. They do however emerge on the opposite face 48 in order to make it possible to insert the heating cartridges into these cavities 41 and to supply power to these heating cartridges.

Recesses 45, in the form of grooves, are made in the cylindrical surface of the body 4 between the spaces 41, in order in particular to increase the surface area for heat exchange between the body 4 and a cooling liquid intended to circulate in a jacket 5, surrounding the lower half of the vessel 3 and in particular part of the vaporization means 84. More specifically, the jacket 5 takes the form of an annular jacket, a first circular edge of which surrounds the body 4 and borders the opposite face 48, and a second circular edge of which surrounds the vessel 3 slightly below the liquid outlet 34 on the vessel 3. The purpose of this jacket 5 will be described below.

The vaporization means 84 act as a bath vaporizer with a thermosiphon effect in the discharge ducts 44. To be specific, during the vaporization step 120, the heating cartridges are supplied with power, and bring the temperature of the cryogenic liquid present in the discharge ducts 44 to its vaporization temperature, allowing the oxygen vaporized to escape, with very few impurities, to the gas outlet 36. Circulation is created owing to the thermal flows, with the cryogenic liquid circulating in the intake duct 42 from the face 46 to the opposite face 48 of the body 4 and then traversing the manifold 8 so as to supply the discharge ducts 44 with cryogenic liquid.

This circulation allows good agitation and good homogeneity of the cryogenic liquid in the vaporization means 84 and in particular on its heating surface formed by the internal surfaces of the discharge ducts 44.

The vaporization means 84 are configured such that this heating surface is still submerged in or wet with the cryogenic liquid at the end of the evaporation step 120, when the volume of non-vaporized cryogenic liquid reaches the predetermined volume of residual cryogenic liquid. By way of indication, in this embodiment of the invention, the body 4 has a height H of 7 mm (millimetres), and the height h reached by the volume of residual cryogenic liquid in the vessel is at least 50% of the height H of the body 4. The circulation brought about by the thermosiphon effect in the discharge ducts 44 thus makes it possible to keep their internal surfaces wet.

In this way, the heating surface, which is a vaporization surface, transfers the heat of vaporization without vaporization to dryness, even locally. There is no liquid/vapour interface on the heating surface since the heating surface is entirely wetted by the cryogenic liquid. Impurity deposits cannot form there and the vapour escapes at thermodynamic equilibrium with a negligible amount of impurities compared to the amount of impurities remaining in the liquid phase.

In order to avoid transmitting heat of vaporization to the cryogenic liquid in the intake duct 42, the internal surface thereof is covered with a thermally insulating lining 47, for example made of Teflon®.

By virtue of the heating cartridges and the good conductivity of the body 4, the thermal flow in the vaporization means is controlled, and this makes it possible to manage the temperature of the heating surface. In particular, the material of the body 4 makes it possible to homogenize the temperature of the internal surfaces of the discharge ducts 44.

The latter have a circular cross section in order to promote good wetting of their internal surfaces, which are smooth or textured, for example porous or having fins in order to improve the heat exchange coefficient, increase the thermal flow and reduce the duration of this vaporization step 120. The low pressure applied in the vessel 3 makes it possible in particular to increase the difference in temperature between the temperature of the heating surface and the vaporization temperature of the liquid without running the risk of allowing an excessive amount of impurities to escape into the gas phase.

The configuration of the body 4, and in particular the disposition of its ducts 43, makes it possible to have a large heating surface which is always wet, even though the volume of residual cryogenic liquid is very small.

By way of indication, the thermal power of these vaporization means 84 makes it possible to vaporize 99% of the initial volume of cryogenic liquid in less than 15 minutes.

At the end of the vaporization step 120, the gas outlet 36 is closed, the vessel being insulated and containing the predetermined volume of residual cryogenic liquid.

The next step is then a step 130 of determining the impurity proportion in the residual cryogenic liquid.

This determination step 130 includes vaporizing 132 all the volume of residual cryogenic liquid, in the vessel 3 which is kept closed, and then delivering 134 the gas thus vaporized and concentrated with impurities to a gas analyser 6 (shown in FIG. 2). This gas analyser determines the proportion of propane in the gas, and then this proportion is divided by the concentration factor to determine the content of propane in the liquid oxygen sampled from the system for separating gases from air. Of course, it is also possible to determine the proportions of other types of impurities in this determination step 130 in the same way, in particular the proportion of nitrous oxide and the proportion of carbon dioxide in the liquid oxygen sampled from the system for separating gases from air.

The next step is a step of emptying 140 the vessel 3, for example by delivering an inert gas which does not contain any impurities to the vessel 3. In a variant, a vacuum is applied to the gas remaining in the vessel by an ejector or a vacuum pump.

The more the vessel 3 is cooled during a cooling step 150, during which a liquid at a temperature lower than or equal to the filling temperature of the cryogenic liquid is delivered to the jacket 5 through a liquid inlet 52 with which the jacket 5 is provided in its lower part. This liquid is for example liquid oxygen. A gas outlet 56 in an upper part of the jacket makes it possible to release a gas phase produced by evaporation of the liquid in the jacket 5 in contact with the hot wall of the vessel 3.

The cooling liquid is then discharged from the jacket 5 through an outlet 54 located in the bottom part of the jacket 5, and the determination system 2 is ready for a new implementation of the determination method 100.

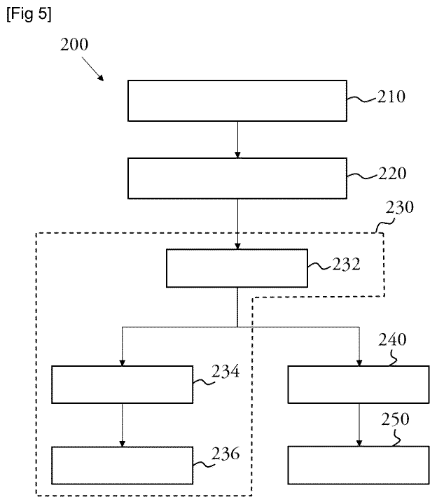

A variant of the determination method 100 according to the invention will now be presented in relation to FIG. 5, showing the steps of a determination method 200 according to the invention.

The determination method 200 according to the invention includes steps of filling 210 the vessel 3 and vaporizing 220 the cryogenic liquid which are identical to the steps of filling 110 and vaporizing 120, respectively, that were described above.

In this variant, during a subsequent step 230 of determining the impurity proportion in the residual cryogenic liquid, not all of the volume of residual cryogenic liquid is vaporized, but a sample is taken 232 of a predetermined volume of this volume of residual cryogenic liquid, which is vaporized 234 entirely and is delivered 236 to the gas analyser 6. This gas analyser determines the impurity proportion from this in the same way as in the determination step 130.

This variant makes it possible to carry out a step of emptying 240 the vessel 3, at the same time as the sample of cryogenic liquid is being vaporized in the separate vessel. During this emptying step 240, the cryogenic liquid remaining in the vessel 3 is for example vaporized and discharged through the gas outlet 36 on the vessel 3.

The vessel 3 is then cooled during a cooling step 250, which is identical to the cooling step 150 of the determination method 100. Once the cooling liquid has been discharged from the jacket 5, the determination system 2 is then ready for a new implementation of the determination method 200.

The invention is described in the context of a cryogenic liquid originating from the separation of air, such as oxygen, nitrogen or argon. It goes without saying that the invention applies to any cryogenic liquid, for example carbon dioxide, carbon monoxide, hydrogen, helium, methane, krypton, xenon, neon.

Of course, the invention is not restricted to the examples that have just been described, and numerous refinements may be made to these examples without departing from the scope of the invention. In particular, the features of the various embodiment variants of the invention envisaged in this application may be combined to realize the invention, provided that these variants are not mutually incompatible.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

We claim:

1. A determination apparatus for determining the proportion of at least one impurity dissolved in a cryogenic liquid, the at least one impurity being less volatile than the cryogenic liquid, the determination apparatus comprising:
a vessel configured to receive an initial volume of the cryogenic liquid;
vaporization means configured to vaporize the initial volume of cryogenic liquid until a volume of residual cryogenic liquid is obtained in which the impurity is concentrated, the vaporization means being disposed in a lower part of the vessel and comprising a heating surface configured to vaporize the cryogenic liquid; and
means for determining the proportion of the impurity in the residual cryogenic liquid,
wherein the vaporization means comprise at least one cryogenic liquid intake duct and a plurality of cryogenic liquid discharge ducts, the vaporization means being configured to produce a thermosiphon effect between the intake duct and the plurality of discharge ducts, the heating surface comprising internal surfaces of the discharge ducts.

2. The determination apparatus according to claim 1, wherein the discharge ducts surround the intake duct.

3. The determination apparatus according to claim 1, wherein the discharge ducts have a smaller diameter than the intake duct.

4. The determination apparatus according to claim 1, wherein the vaporization means comprise a thermally conductive body of cylindrical overall shape, through a height of which are made the intake duct and the discharge ducts, which emerge on a face of a body that delimits a bottom part of the vessel.

5. The determination apparatus according to claim 4, wherein the body comprises a thermally insulating lining disposed between the intake duct and the discharge ducts.

6. The determination apparatus according to claim 4, wherein the vaporization means comprise at least one electric heater disposed in a recess in the body proximal to the discharge ducts.

7. The determination apparatus according to claim 6, wherein the vaporization means comprise multiple electric heaters in the form of heating cartridges, the body having spaces which are disposed around the discharge ducts and accommodate the heating cartridges, the spaces not emerging on the face of the body that delimits the bottom part of the vessel.

8. The determination apparatus according to claim 7, wherein the spaces are separated by recesses around the circumference of the body, over at least part of the height of the body.

9. The determination apparatus according to claim 4, wherein the body has an opposite face to the face delimiting the bottom part of the vessel and the vaporization means comprise a manifold disposed on the opposite face, the manifold fluidically connecting the intake duct to the discharge ducts.

10. The determination apparatus according to claim 1, wherein a jacket surrounds the vaporization means, the jacket being configured to contain a cooling liquid that comes into contact with the vaporization means.

11. The determination apparatus according to claim 10, wherein the opposite face emerges out of the jacket, the intake duct and discharge ducts extending through the jacket from the face delimiting the bottom part of the vessel.

12. The determination apparatus according to claim 11, considered in dependence on claim 7 or 8, wherein the opposite face has orifices for insertion of the heating cartridges into the spaces.

13. A system for separating gases from air by cryogenic distillation, comprising:
the determination apparatus according to claim 1,
means for taking a sample of fluid circulating in the separation system,
means for liquefaction of the fluid sampled, if it is gaseous, and
means for delivering the fluid sampled, and possibly liquefied, to the vessel so as to determine its impurity proportion.

14. A method for determining the proportion of at least one impurity dissolved in a cryogenic liquid, the at least one impurity being less volatile than the cryogenic liquid, the method comprising the steps of:
providing the determination apparatus according to claim 1;
filling the vessel with the initial volume of cryogenic liquid, kept at a filling temperature and pressure that prevent the cryogenic liquid from vaporizing during this filling step;
vaporizing the cryogenic liquid until the volume of residual cryogenic liquid is obtained by the vaporization means, bringing the cryogenic liquid to its vaporization temperature at the pressure of the cryogenic liquid during this vaporization step, this pressure being less than or equal to the filling pressure, the gas produced by the vaporization being discharged from the vessel; and
determining the proportion of the impurity in the residual cryogenic liquid.

15. The method as claimed in claim 14, wherein the pressure within the vessel during the vaporization step is brought to a value ranging between 0.2 bar and 0.3 bar and preferably equal to 0.2 bar.

16. The method as claimed in claim 14, wherein the determination step comprises taking a sample of the residual cryogenic liquid and then vaporizing the sampled liquid to afford a gas, or else vaporizing all the residual cryogenic liquid to afford a gas and then delivering the gas obtained by vaporization of the sampled liquid or all the residual cryogenic liquid to a gas analyser.

17. The method as claimed in claim 16, wherein the determination apparatus provided further comprises a jacket that surrounds the vaporization means, the jacket being configured to contain a cooling liquid that comes into contact with the vaporization means, wherein the method further comprises a step of emptying the vessel, followed by a step of cooling the vessel by introducing a liquid at a temperature less than or equal to the filling temperature of the cryogenic liquid into the jacket of the determination system.
